(19) United States
(12) Patent Application Publication
(10) Pub. No.: US 2017/0053064 A1
(43) Pub. Date: Feb. 23, 2017

(54) PERSONALIZED CONTENT-BASED PATIENT RETRIEVAL SYSTEM

(71) Applicant: SemanticMD, Inc., Pittsburgh, PA (US)

(72) Inventor: Santosh Bhavani, Pittsburgh, PA (US)

(21) Appl. No.: 15/253,771

(22) Filed: Aug. 31, 2016

Related U.S. Application Data
(63) Continuation of application No. PCT/US2015/018531, filed on Mar. 3, 2015.
(60) Provisional application No. 61/947,218, filed on Mar. 3, 2014.

(51) Int. Cl. G06F 19/00; G06F 17/30

(52) U.S. Cl. CPC G06F 19/321; G06F 19/3406; G06F 17/30268; G06F 17/30277; G06F 17/3053

(57) ABSTRACT

This disclosure provides methods and a personalized system for retrieving similar image-based subject data. A method for adaptive learning of imaging data comprises accessing a subject database comprising subject imaging data. Next, a search of the subject database is conducted using one or more search parameters, which can include one or more image data associated with a subject undergoing treatment. The search can include comparing using an image comparison algorithm the one or more search parameters to the subject imaging data. Next, at least one match of the search can be provided on a user interface. The match can include one or more imaging data each associated with a known or identifiable condition. The image comparison algorithm can then be updated based on an indication as to whether the one or more matches accurately relate to the one or more image data associated with the subject.

### CROSS-REFERENCE

This application is a continuation application of International Application No. PCT/US2015/018531, filed Mar. 3, 2015, which claims priority to U.S. Provisional Patent Application Ser. No. 61/947,218 filed Mar. 3, 2014, all of which are entirely incorporated herein by reference.

### BACKGROUND

Medical imaging systems, such as computerized tomography (“CT”) scanners and magnetic resonance imaging (“MRI”) scanners, may allow a treating physician to examine a patient's internal organs and areas of the patient's body that require a thorough examination for medical treatment. In use, a visualizing scanner may output two-dimensional (“2D”) and three-dimensional (“3D”) medical images that may include a sequence of computerized cross-sectional images of a certain body organ of the patient, which may then interpreted by reviewing physician, such as a specialized radiologist. Radiologists are typically trained to analyze medical images from various parts of a patient's body, such as medical images of the brain, abdomen, spine, chest, pelvis and joints. After a radiologist analyzes the medical images, the radiologist prepares a document or report that includes radiological findings, and sometimes key images from the scan that best show the findings. The radiology report is then sent back to the referring practitioner.

Images from medical imaging systems may be automatically processed and analyzed using imaging systems. Imaging systems can comprise a variety of components such as imaging devices and information technology systems to interpret the image data. These components can be implemented and installed by different vendors.

### SUMMARY

Recognized herein are various limitation associated with the manner in which medical data is processed and analyzed. For instance, use of different vendors may result in a fragmented information technology environment and the increase in heterogeneous data sources can be barriers to providing efficient service. As another example, current systems for data analysis, including medical imaging analysis, may not provide information at a requisite level of accuracy within a timeframe that may be suitable to permit rapid diagnosis or treatment. Accordingly, recognized herein is the need for new methods in integrating and searching multi-vendor, unstructured data.

In an aspect, the present disclosure provides for a method for adaptive learning of imaging data, comprising, (a) upon request by a user, accessing a subject database comprising subject imaging data, which imaging data is related to a physiological state or condition of one or more subjects, wherein at least a fraction of the subjects have known or identifiable physiological conditions, (b) using a computer processor, conducting a search of the subject database directed to search parameters provided by the user, wherein the search parameters include one or more image data associated with a subject undergoing treatment, and wherein the search comprises comparing, using an image comparison algorithm, the one or more search parameters to the subject imaging data in the database; (c) providing, on a user interface of an electronic display of the user, one or more matches of the search, which matches include one or more imaging data among the subject imaging data each associated with a known or identifiable condition; (d) retrieving from the user an indication as to whether the one or more matches of (c) (i) accurately relate to the one or more image data associated with the subject or (ii) do not accurately relate to the one or more image data associated with the subject; and (e) updating the imaging comparison algorithm based on the indication of (d). This can enable the image comparison algorithm to identify an image that matches a search parameter at an increasing level of accuracy, such as at an accuracy that is at least about 70%, 80%, 90%, 95%, or 99%. This can advantageously enable the rapid and accurate identification of images from search parameters in a relatively rapid time scale, thereby providing for improved diagnosis and/or treatment of a subject having an unknown physiological condition or physiological condition that is not readily identifiable.

In another aspect, the present disclosure provides for a system for adaptive learning of imaging data, comprising (a) a profile module programmed to allow a user to make a profile, the profile comprising a relevance function selected for the user; (b) a query module programmed to query a patient database for search parameters selected by the user; (c) a retrieval module that is programmed to use the relevance function to retrieve patient data from the patient database based on the query; and (d) an adaptive learning module that is programmed to (i) format the patient data for display on a graphical user interface of an electronic device of user, which patient data is displayed together with a similarity rating that is generated based on similar patients that are identified based on the content of the query, and a relevance score, and (ii) adaptively learn the preferences of the user and update the relevance function based on the patient data, similarity rating and relevance score displayed on the graphical user interface of an electronic display.

In another aspect, the present disclosure provides for a method for recommending imaging data, comprising (a) upon request by a user, accessing a subject database comprising subject imaging data, which imaging data is related to a physiological state or condition of one or more subjects, wherein at least a fraction of the subjects have a known or identifiable physiological conditions; (b) using a computer processor, conducting a search of the subject database directed to search parameters provided by the user, wherein the search parameters include one or more image data associated with a subject undergoing treatment, and wherein the search comprises recommending, using a recommending algorithm, the subject imaging data in the database; (c) providing, on an electronic display of the user, one or more recommended imaging data; (d) retrieving from the user an indication as to the clinical evaluation of the imaging data; (e) evaluating the clinical evaluation, wherein the evaluating comprises determining the accuracy of the clinical evaluation; and (f) updating the recommending algorithm based on the indication of (d) and accuracy of (e).

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 depicts an exemplary embodiment of the information system of the disclosure.

FIG. 2 depicts exemplary search parameters that a user can use to compare images.

FIG. 3 depicts an exemplary control system of the disclosure

FIG. 4 depicts an exemplary embodiment of the feedback module of the system of the disclosure.

FIG. 5 depicts a table of exemplary types of user feedback that can be collected along with exemplary methods to update a relevance function based on this feedback.

FIG. 6 is depicts an exemplary embodiment of the recommender module of the system of the disclosure.

FIG. 7 is depicts an exemplary embodiment of the assignment module of the system of the disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used herein, the term “data sources” or “patient data” generally refers to any data that can be utilized for defining similarity between patients. Exemplary data sources can include patient images, radiological annotations, and electronic health records. Patient data can refer to images and/or data from a subject.

As used herein, the term “context” generally refers to any non-empty subset of the patient data. A context can refer to either the characteristics of the input data or the characteristics of the output data. A context can refer to search parameters.

As used herein, the term “user” generally refers to any healthcare professional working with patient data. Exemplary users can include a radiologist, a caregiver, an imaging technician, a doctor, a medical professional, and/or a scientist.

As used herein, the term “clinical features” generally refers to any information that can be extracted from patient data (e.g., images, clinical data, ontology data, symptoms, and diagnoses) either manually by a human (e.g., radiologist) or automatically by a computer program.

As used herein, the term “relevance function” generally refers to any mathematical function or algorithm that takes as input clinical features from a set of patients and computes a continuous value indicating the relevance of the patient set to the current user. A relevance function can be uniquely defined for a specific user. A relevance function can be used interchangeably with an “image comparison algorithm.”

As used herein, the term “similarity measure” generally means any mathematical function or algorithm that takes as input clinical features from two different patients and computes a continuous value indicating a measure of similarity between the two patients.

As used herein, the term “PACS” generally refers to a Picture Archiving and Communication Systems. This can be a secure network used by users that enables secure distribution, exchange, storage, and displaying of patient images and related reports. In some embodiments, a PACS can include a workstation or mobile device.

As used herein, the term “HIS” generally refers to Health Information System. This can be any system that stores, retrieves and manages information related to the health of patients or the activities of organizations within a healthcare network.

As used herein, the term “RIS” generally refers to a Radiology Information System. This can be a computer program that stores and retrieves radiology information during all stages of the radiological workflow. RIS can enable patient scheduling as well as report generation.

As used herein, the term “EHR” generally refers to an Electronic Health Record. This can be an electronic format that supports entry of patient health data, wherein the data may be entered into the EHR platform by the individual or a healthcare professional with varying levels of access to the data.

As used herein, the term “image acquisition system” generally refers to a system capable of collecting and processing digital patient images (e.g., magnetic resonance images, x-rays). For an example, a positron emission tomography (PET) scanner can produce 3D images which can be processed on the machine.

As used herein, the term “subject” generally refers to an individual receiving treatment, in need of treatment, suspected of needing treatment, or suspected of having an ailment or health condition. A subject can be a patient.

Medical imaging systems, such as computerized tomography (“CT”) scanners and magnetic resonance imaging (“MRI”) scanners, allow a physician to examine a patient's internal organs and areas of the patient's body that require a thorough examination for medical treatment. In use, a visualizing scanner outputs two-dimensional (“2D”) and three-dimensional (“3D”) medical images that can include a sequence of computerized cross-sectional images of a certain body organ, which is then interpreted by a reviewing physician, such as a specialized radiologist.

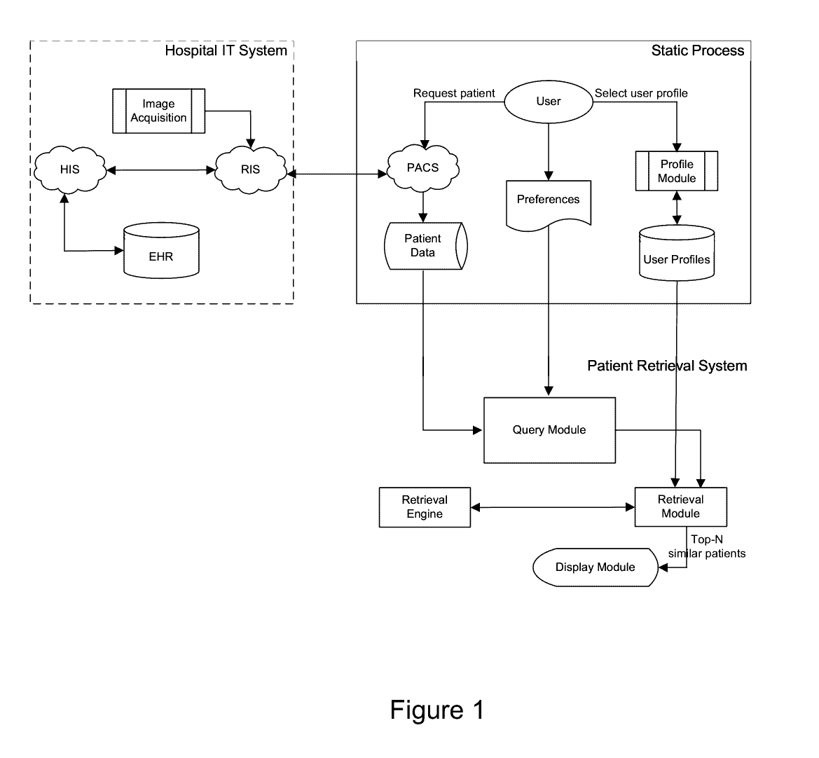

As shown in FIG. 1, in radiology, the information technology environment can comprise: a hospital information system (HIS), a radiology information system (RIS), an image acquisition system, and a picture archiving and communication system (PACS). Picture archival and communication systems (PACS) can connect the different aspects of the radiological workflow: image acquisition, storage, transmission, viewing, processing, interpretation, and reporting.

The information system of the disclosure can be designed to learn a personalized content-based patient retrieval system for the radiologist. The radiologist can query for patients similar to the patient being currently annotated and the retrieval system can provide a list of similar patients sorted by the degree of relevance to the radiologist. Relevance can be a measure of importance to a given radiologist based on one or more known preferences of the radiologist. Relevance can be a measure of how closely an image is related to a parameter provided by a radiologist based on one or more known preferences of the radiologist. The system can enable a federated search of patient data in order to identify relevant patients for the radiologist. The system can reduce the time that it takes a radiologist to review patient data by increasing the efficiency of an interaction between the radiologist and the information system. The system can provide a normalized nomenclature for patient data across a variety of information technology services based on preferences of the radiologist.

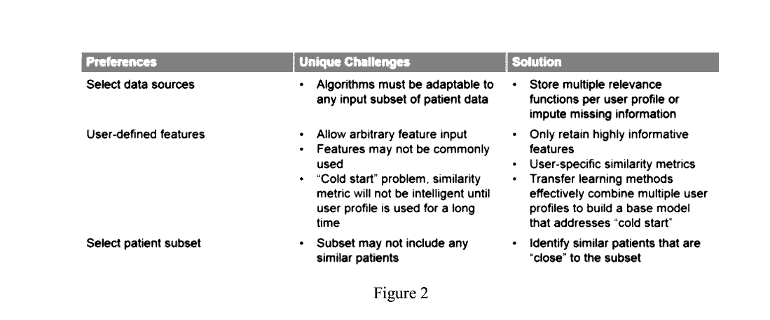

For example, a radiologist can begin annotating an image of a patient and the retrieval system can dynamically update a list of similar patients based on the current radiological annotation data. Annotating a patient can refer to grading and/or describing a patient based on their clinical features (e.g., tumor, broken bones). The annotation can comprise identifying a clinical feature. The annotating can comprise grading the degree of severity of the clinical feature. FIG. 2 depicts exemplary search parameters for comparison between images. The system can bring up different views for multiple patients with the appropriate viewer supplied by PACS. For example, a study which includes a magnetic resonance imaging (MRI) of the brain might be viewed using a specialized 3D viewer.

Some embodiments of the disclosure provide systems and methods for using a computer to retrieve images from a database and to determine whether each of the images is of medical interest to a reviewing physician. In some cases, systems and methods are provided for using the computer to determine which one (or more) of the images is representative of the full set of images and providing that representative image or images to a display and analysis system for review by a reviewing physician. Subject (e.g., patient) outcomes may be tracked (e.g., monitored) by continuously following the initial findings and the responsiveness to treatment. By tracking patient outcomes the diagnostics can be further enhanced and refined over time, thus improving the results.

In some embodiments, an image retrieval and analysis system is programmed to retrieve subject images and enable a user to analyze the images. The system can look at an image annotated by a radiologist and compare it to the system's automatically generated similar images, adjusting and/or refining algorithms to more closely match the radiologist's annotations. This approach involves automatic processing of many cases and using analytics/statistical processing of vast amounts of data to improve diagnostic algorithms and hence patients outcome.

The disclosure provides methods and systems for analyzing and prioritizing medical images. For example, an analysis of medical images may be used to identify critical medical conditions, and, based on this analysis, the system and methods may further be used to organize a work list for a reviewing physician based on the severity of the medical findings and to then create a text document that lists the medical findings in the analyzed medical images. Deviations above a certain threshold (e.g., user defined search parameter, and/or machine learned user profile relevance algorithm) may be used to flag a certain image. Furthermore, in some areas, just the appearance of an unexpected presence (for example, a liquid in the pleural space) maybe used to flag an image or a series of images. It is clear that many variations can be done without changing the spirit of the invention.

Various aspects of the disclosure may be applied to any of the particular applications set forth below or for any other types of displays, or radiological data management applications. The system of the disclosure may be applied as a standalone system or method, or as part of an integrated software package, such as a medical and/or laboratory data management package or application, or as part of an integrated picture archiving communication systems (“PACS”) solution. The system of the disclosure may also be integrated with an image acquisition device such as a handheld ultrasound machine. It shall be understood that different aspects of the invention can be appreciated individually, collectively, or in combination with each other.

A computer system can be provided for improving the efficiency and accuracy of a workflow process. In some embodiments of the disclosure, the computer system, which, for example, could be a standard personal computer with a standard CPU, memory and storage, is an enhanced picture archiving communication system, or an add-on subsystem to an existing PACS and/or RIS. In some embodiments, the computer system can be configured to analyze and prioritize images and patient cases. The computer system can automatically retrieve medical images from an imaging modality (e.g., CAT/CT scanner, MRI, PET/CT scanner) or a database in which medical images are stored, or a PACS, automatically analyze the medical images, and provide the medical images and the results of the analysis for review by a reviewing or referring physician, or a specialist, such as a radiologist.

One or more images (or set of images) of a patient can be stored in an image database. The image database can be a subsystem of a PACS. The image database can be a standalone computer system. In such a case, the standalone computer system can be in communication with a PACS.

The user can query a database comprising a plurality of patient images from a plurality of patients. The query can comprise asking the database to find, for example, similar images, patients, and/or patient diagnoses. The query can be based on the search parameters entered by the user. The query can ask the retrieval module/engine to find data related to the query in the database.

The one or more images retrieved by the retrieval engine can be analyzed and interpreted by the system of the disclosure. For example, the one or more images can be analyzed to determine whether the one or more images would or are likely to be of interest to a reviewing or referring physician. This can entail determining whether the one or more images show any abnormalities with respect to the current patient's condition. These various conditions, for example, can be determined using comparable images, as well as comparing them to normalized images.

The systems can determine whether each or a subset of the one or more images is important for further review by a reviewing or referring physician. In some cases, the systems may perform additional analysis, including but not limited to providing quantitative measurements, providing a relevance score, providing a similarity rating, and providing a relevance function.

In some instances, methods for retrieving and processing medical diagnostic images are provided. The methods comprise using a computer system, such as an enhanced picture archiving communication system, to retrieve one or more images (e.g., two-dimensional images from a three-dimensional scan) from an image database or directly from an imaging device (e.g., imaging modality). In some embodiments, the one or more images define a set of images. The computer system can determine whether each of the images is of medical interest to a reviewing physician, for example, by generating a relevance score. In some embodiments, this can include the computer system comparing each of the images to images from patients with known medical conditions. The computer system can provide the one or more images to a display and analysis system for review by a reviewing physician. The computer system can format the image data such that the one or more images can be provided for display on a graphical user interface for review by a reviewing physician. In addition, using the above image comparisons, the computer system can detect whether a patient suffers from a particular ailment, and provide a reviewing physician quantitative information (e.g., distances, cross-sectional areas, volumes), that is relevant to the patient's condition.

Systems and methods of the disclosure can comprise a user-specific profile; matching of similar patients; obtaining medical data relevant to the patient; determining relationships between patients based on patient data content; integrating domain knowledge of users in addition to medical data in order to determine relationships between patients; and retrieving medical data based on the learned relationships. The personalized content-based patient retrieval systems may be used during the image analysis, interpretation, and reporting steps of the radiological workflow.

The information systems of the disclosure can allow radiologists to more easily identify relevant patients (e.g., patients with similar conditions); thereby, improving the productivity of radiologists. The information systems can include the integration of radiological annotations, patient images, and any prior patient health data for searching as well as a personalized retrieval system which learns each individual radiologist's relevance function and provides personalized search results. Retrieval systems can index data in a variety of ways not limited by the structure of a database.

Information Systems

Information systems of the present disclosure can be used in a variety of formats. An information system can comprise a stand-alone application or an application that is integrated with a PACS or a subsystem of a PACS. The information systems can comprise a web application. The information systems can comprise a mobile application. The information systems can comprise a distributed application. The information systems can be Internet-based. The information systems can be intranet-based. The information systems can be cloud-based.

Profile Module

The systems can include a profile module. A profile module can allow the user to select an existing relevance function or create a new personalized search function by creating a new profile. In some embodiments, a profile module allows a user to select a search function personalized for a group of users (e.g., an entire radiology department). A profile module can be programmed to allow a user to make a profile. A profile can comprise a relevance function selected for the user. A user can edit information in the profile module through a graphical user interface (UI).

A profile module may enable a user to select a user profile with a search function which can incorporate a relevance function based on the user's past behavior in the system. A profile module may enable a user to select a user profile with a search function which can incorporate multiple user relevance functions across all combinations of data sources. A profile module can make possible the definition of a personalized relevance function which is learned from prior usage of the system by the user.

A user can input a file containing profile information. A profile module can comprise a graphical user interface (GUI) to incorporate user input. A profile module can interact with a database of user profiles. A user profile can be defined on a local storage device. A profile module can access patient data from multiple external databases to define a user's relevance function.

In some embodiments, a profile module allows the user to select any non-empty subset of the existing user profiles, thereby initiating multiple queries of the system. Since the personalization aspect of the system can be based on the defined user profile, the user can reduce bias by utilizing multiple profiles. The user can integrate multiple user profiles to create a new profile capturing the average behaviors of the combined user profiles. The profile module can allow a user to optionally define non-empty subsets of user profiles for different types of patient data to personalize search results for various workflows.

Query Module

The systems can comprise a query module to allow the user to request search results for a given patient query. The query module can query patient data. The query module can be programmed to query a patient database for search parameters selected by a user. Patient data can be stored in a database. Patient data can comprise clinical data, ontology data, symptoms, and imaging data, diagnoses, or any combination thereof. A query module can allow the user to select any input context that can be utilized for searching and defining the relevance function. The query module can pass information to other modules (e.g., the retrieval module) in response to a user action.

In some embodiments, a query comprises two components: a set of user preferences and access to the current patient data. The user preferences can be stored in a data file. The user preferences can specify some output context for which search results are sought. For example, a search result can be sought which compares patients only based on their radiological annotations.

A user can input a file comprising the user preferences to the query module. The query module can format the input file to define a user's relevance function. A query module can provide a graphical user interface (GUI) to incorporate user input.

Retrieval Module

The systems can include a retrieval module which can respond to the query module by making search results. The retrieval module can utilize a user profile and query to make search results.

A retrieval module can process requests by making search results in an output context using a user profile defined for some input context (e.g., search parameter). A retrieval module can process requests by making multiple search results in an output context for a set of user profiles defined for some input context (e.g., the query). A retrieval module can process requests by making search results which includes a relevance score indicating the reliability of the search results. Reliability of the search results can be based on a statistical measure of confidence in the accuracy of the search results. A reliability of the search results can be based on a calculation of error in the search results. A retrieval module can process requests by making search results which include a similarity rating indicating the level of similarity to the current query.

In some embodiments, a retrieval module continually interacts with a separate retrieval engine. In some embodiments, a retrieval module outputs search results to a display module.

Retrieval Engine

The systems can include a retrieval engine which can interact with the retrieval module to compare patients given the inputs from the retrieval module. The retrieval engine can be integrated with the retrieval module.

A retrieval engine can include an algorithm that enables the integration of heterogeneous patient data. A retrieval engine can retrieve data for a query in less than 1, 2, 3, 4, 5, 6, 7, 8, 9, or 10 or more milliseconds. A retrieval engine can retrieve data for a query in more than 1, 2, 3, 4, 5, 6, 7, 8, 9, or 10 or more milliseconds. A retrieval engine can take an input context (e.g., search parameters) and extract clinical features. For example, a retrieval engine can mine a database comprising the patient data that the user can query for. The retrieval engine can include a statistical model that allows comparison of patients based on clinical features.

In some embodiments, a retrieval engine processes requests even in the case of missing data in the input or output context. For example, the user can select comparison of patients with an input context that has missing data and the retrieval engine can impute the missing data before performing comparisons. A retrieval engine can impute missing data within a context by matching users with similar patient data. A retrieval engine can enable the aggregation of multiple imputations and matches.

In some instances, a retrieval engine can generate a relevance function (e.g., image comparison algorithm). The relevance function can be generated by comparing input data to database data. For example, the input data can correspond to the user query (e.g., search parameters). The input data can be searched against database data. The database data can comprise previously accumulated patient data. When the input data is compared against the database data, a relevance function is generated to indicate how similar the input data and the relevance data are.

In some embodiments, a retrieval engine enables the user to use a specified relevance function defined in a user profile to compute the relevance of a set of patients to the current user. A retrieval engine may include a similarity rating in the calculation of relevance. In some cases, a similarity rating can comprise a numerical value within a predetermined numeric range where value at one end of the range indicates a low rating and a value at an opposite end of the range indicates a high rating. In some cases, the range can be a percentage range.

Display Module

The systems can include a display module which interacts with the retrieval module to present search results sorted by relevance to the user. The display module can be programmed to provide search results on a graphical user interface (UI). In some embodiments, the display module may be integrated with the PACS system. Search results can be formatted for display to a user in the display module.

In some embodiments, a display module can display both the patient identification and the percent similarity to the query. The display module may include a metric indicating the confidence in the search result output as a percentage.

The systems can include a display module which displays the similar patients to the current patient being queried, allows the user to provide feedback, and reports to the feedback module. The number of patients that can be displayed can be at least 10, 20, 30, 40, 50, 60, 70, 80, 90 or 100 or more patients. The number of patients that can be displayed can be at most 10, 20, 30, 40, 50, 60, 70, 80, 90 or 100 or more patients.

A display module can include a graphical user interface (UI) to display the similar patients. A display module may include information about the level of relevance for each result. For example, the display module can include a percentage similarity measure to the current query patient for all patients displayed.

In some embodiments, a display module allows for explicit feedback. For example, a graphical user interface (UI) in the display module can enable the user to select the most relevant patient data from the search results.

A display module can allow for implicit feedback. For example, the display module can track which patient data was selected from the search results and the amount of time spent on each patient which will be reported to the feedback module.

A display module can allow the user to refresh search results, which can initiate a new query being sent to the retrieval engine. The display module may automatically refresh search results based on a relevance function method. The display module can be useful for not only displaying relevant search results, but for also providing a method to gather feedback from the user.

In some instances, a display module can comprise a graphical user interface comprising an interactive window that enables a user to review images associated with each case, in addition to data provided by the systems. The interactive window can also permit a user to provide notes, including her/his assessment of the patient's condition. The interactive window can include a case or scan selection panel (or list), a window for displaying an image selected from the panel, an interactive report window with information relevant to each image in the image window, a findings navigator window that indicates the ailments or conditions (e.g., right pleural effusion) identified by the systems for the reviewed scan, and menu features to permit a user to generate a report and change the image visualization parameters (e.g., contrast or brightness), resize and center the window. The interactive report window can include the patient's identification (“ID”) number, the modality (CAT/CT scan, MRI, PET/CT scan) used to acquire the images, the associated anatomical features, and/or the system's assessment of the patient's condition. The interactive report window can include other information, such as whether the priority associated with the patient's case, and whether the image displayed in the window is a high priority image. The interactive report window can permit a user to provide additional information, such as additional findings with respect to the image shown in the window, and to edit the information provided by the system.

In some instances, a display module comprises a findings navigator window. A findings navigator window can be used by the reviewing physician to quickly navigate to and visualize in the image display window images the system automatically associated with each of the findings (e.g., images) that are listed in the findings navigator window. The systems can automatically adjust the visualization parameters of the image (e.g., contrast, brightness), or part of the image (e.g., highlighting the body organ in which an ailment was detected by the system) displayed in the image display window to help the reviewing physician better see or visualize the particular finding or findings.

Feedback Module

The systems can include a feedback module which processes feedback from the display module and reports to the relevance engine. A feedback module can combine both implicit and explicit feedback. A feedback module may include a statistical method for combining different types of user feedback.

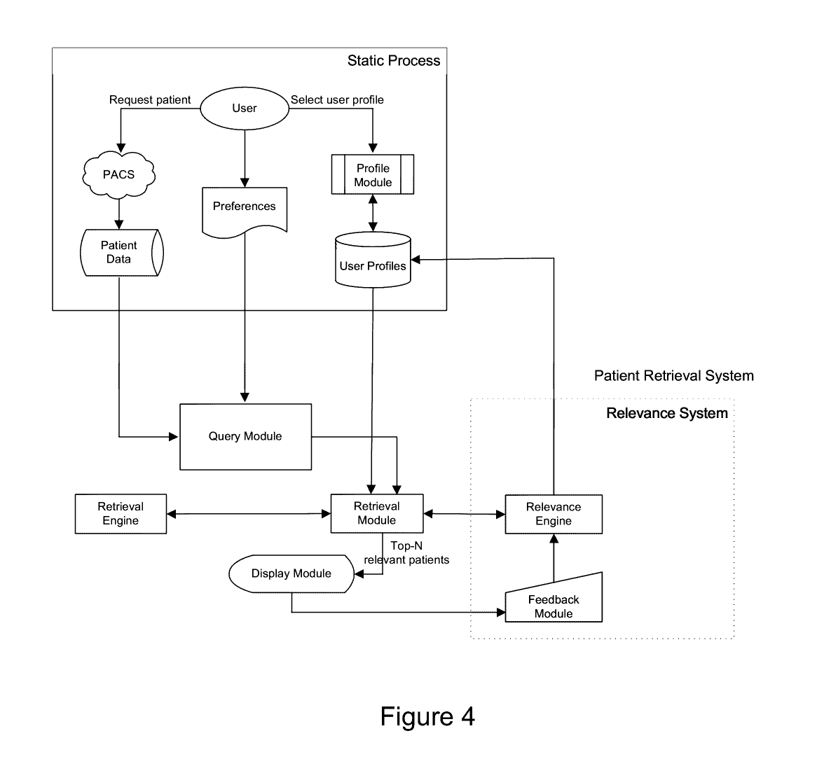

FIG. 4 illustrates a feedback module incorporated into the systems of the disclosure. The feedback module can be in communication with a relevance engine and the display module. The feedback module can collect feedback from the display module and format the feedback for use by the relevance engine. The display module can interface with the user, wherein the user can provide feedback to the feedback module. The feedback module can incorporate the feedback into the relevance engine, which updates the searching and retrieving of the database.

The feedback module can filter user feedback from the display module to identify relevant feedback. The feedback module may include an algorithm to extract the relevant data from the feedback.

The feedback module can parse the feedback into a format suitable for the relevance engine. The feedback module may include a data buffer which can store user feedback for some period of time before reporting to the relevance engine. The feedback module can gather as well as federate multiple sources of feedback.

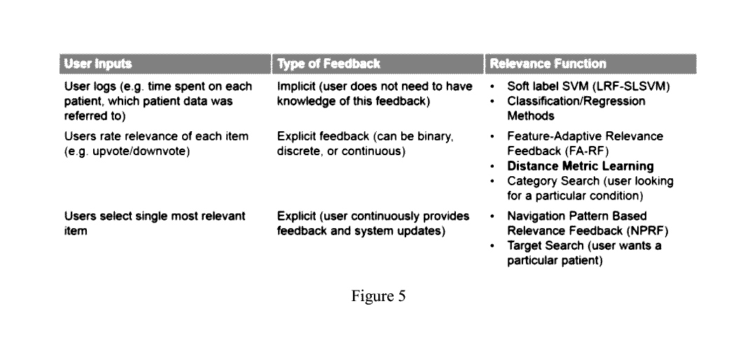

User feedback both implicit and explicit can be used to infer the relevance of patient data to the user. The user's updated relevance function can be used to provide a set of matched patients which are most relevant to the user given the current query. A pairwise question of whether or not two patients are similar can be directed to the user. The feedback to this pairwise question can impose a constraint on those two patients being assigned the same condition as well as can teach the system which features are important in comparing patients for the current query. FIG. 5 describes types of feedback from users and how this feedback can affect the relevance function.

The feedback module can collect detailed logs on the user's search history. For example, a search history can include how long the user spent on each patient's data and which data was referred to. The search history can comprise the number of user selections on an image. A user selection can include a click, tap, highlight, or mouse-over on an image. The logs of a collected search history can span the entire time that the user interacted with the system. Collecting this search history can allow the systems to use implicit feedback from the user to update the relevance function.

Recommender Module

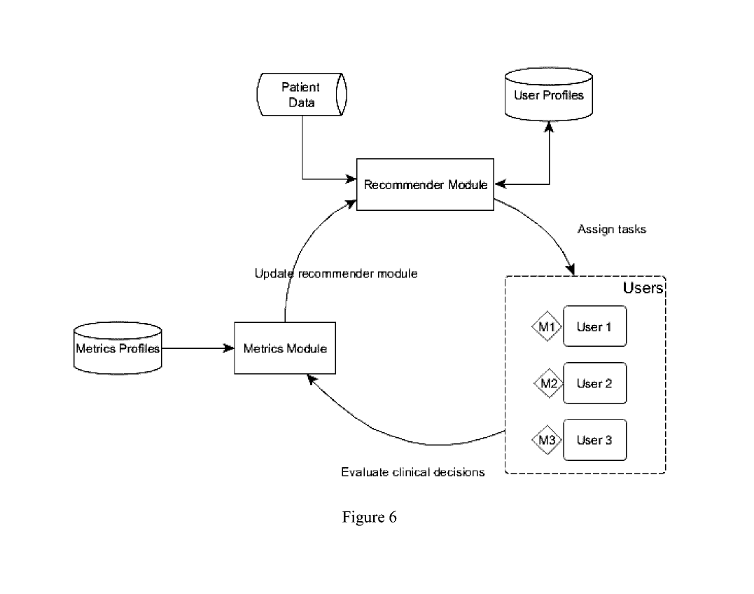

The systems can include a recommender module which can assign unannotated patient data (e.g., radiological readings) to users based on their user profiles. As described in FIG. 6, a recommender module can incorporate patient data and user profiles to recommend tasks for users. When the users complete the tasks their work can be evaluated by a metrics module. The changes in the metrics in the metrics module can update the algorithm of the recommender module to change the recommendations of readings to users.

A user may be represented by a statistical model which can capture the past behavior and accuracy of the user and users can be compared based on their statistical model representations. Accuracy can be based on a percent match between data entered by the user and data that is defined as correct that correspond to the data entered by the user. This comparison provides the basis for how the recommender module recommends tasks. A user can be given a few example readings and statistical tests are used to assess inter-observer agreement as well as how well the user conforms to a standard (e.g., a department standard). Users may be periodically provided test readings based on their currently assessed weaknesses. Assigning test readings based on one or more weaknesses identified for a specific user can result in targeted learning methods for each user such that a user can be trained for efficiently.

The systems can learn over time how users perform on various medical procedures and can effectively provide tests individualized to each user to assess and improve the users' performance. During the continual process of training and grading users, the systems can provide objective metrics for assessing quality of care in a hospital setting. Over time users can be provided with training in areas where they have specific weaknesses. Specifically targeting an individual learner's weaknesses can result in more effective training of the user.

The systems can be designed to both train radiologists and assess the efficacy of radiologists. The systems can request the radiologist to complete a radiology imaging study selected by the system. This can allow the systems to learn the deficiencies of the radiologist faster than randomly assigning studies. Hence, instead of the user spending time browsing, filtering, and identifying studies that may suit the needs of a particular radiologist, the systems can intelligently recommend studies based on knowledge value or other preferences.

In some embodiments, a recommender module accesses a database of user profiles to retrieve information about each user. The user profile can include a statistical model that allows the recommender module to estimate the expected efficacy of a user given a reading. The recommender module can update the user profile on the database.

A recommender module can allow for manual assignment of tasks to users. For example, a healthcare professional can recommend a study to each radiologist based on the information in the user profile.

In some embodiments, a study recommender module provides automated study recommendations. Studies can be recommended based on maximizing expected efficacy of the current user. For an example, the recommender module can assign each study only to the user with the highest predicted efficacy for that study. The recommender module can assign readings based on maximal information gain for each user. For example, the recommender module can use the statistical model associated with each user as a guide to understand the strengths and weaknesses of the user's understanding and provide studies that could maximally improve the user's understanding. The recommender module can have a dual strategy of providing studies based on balancing information gain for users and efficacy of users. For example, radiology residents may not have much prior training so the recommender module can provide studies to train the residents but for more senior radiologists the recommender module might only provide studies with the highest predicted efficacy.

In some embodiments, the clinical decisions of the users may be combined before being sent to the metrics module. A user's clinical decision can be weighted by their expected efficacy. For example, users identified as good learners can be given higher weights for their clinical decisions. Similarity between users may also be computed so that clinical decisions can be compared between users.

Readings may be assigned to users based on the content of the readings. For example, a content-based filtering method can identify which clinical features are best identified by a user and readings with those specific clinical features can be assigned to that user. Collaborative filtering (similarity between users) and/or content-based filtering (similarity between items) can be used to assign readings to users.

Metrics Module

The systems can include a metrics module which can evaluate an annotated reading based on quality of care metrics and reports back to the recommender module.

In some embodiments, a metrics module evaluates the quality of care given a set of annotated readings from a set of users. The metrics module can automatically evaluate the metrics on the readings. Another user can manually evaluate the metrics on the readings.

In some embodiments, a metrics module incorporates one or more quality of care metrics. A metrics module can define a new quality of care metric. A new quality of care metric can comprise a weighted average of three different quality of care metrics. The metrics module can access a database of metric profiles associated with each user. The metrics module can report the evaluated quality of care for each reading and each user to the recommender module.

Assigner Module

The systems can include an assigner module which can provide a new reading to the user based on estimation of the current user's cost and efficacy from the current user profile and metrics profile.

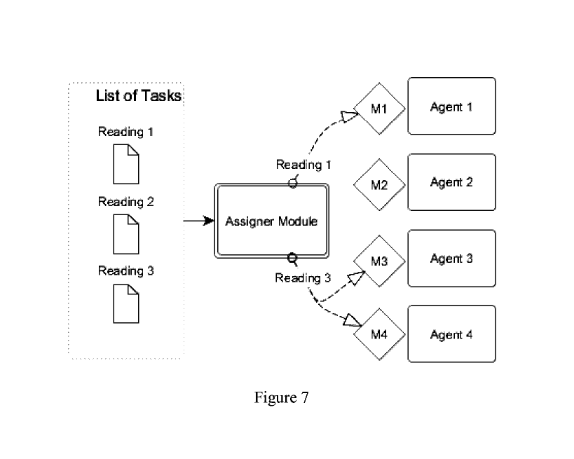

As described in FIG. 7, an assigner module can incorporate a list of tasks (e.g., readings) and assign the readings to users (e.g., agents).

The assigner module can be programmed to execute a proactive learning method which jointly estimates both the cost and efficacy of multiple radiologists given a set of readings. A group of users (e.g., radiologists) comprising differing levels of reliability, cost of reading, and expertise in various domains can be selected for a job and the system can assign readings to radiologists based on a joint estimation of their cost and efficacy. The same reading may be assigned to multiple radiologists. Different readings may be assigned to multiple radiologists.

The system can distribute readings to minimize long-term costs to the hospital or radiology group, while maintaining an overall quality of care standard. Hence, for a reading, the system can estimate both the cost in resources (e.g., turnaround time and money) for each radiologist as well as estimate the efficacy of the radiologist.

The system can receive a set of tasks and for each task the assigner module determines which subset of the agents to query for completing the task. The assigner module can make use of a statistical model associated with each agent to determine the efficacy and cost of each agent for the particular task. The assigner module can output a decision rule which minimizes overall costs given quality constraints. The cost of performing a task can include the turnaround time of the agent, the difficulty of the task, and the total monetary costs of having the agent complete the task.

he systems can assign the same task to multiple agents and the clinical decisions may be combined later in the workflow. The systems may assign tasks specifically to agents that are predicted to perform the best at the task; thereby, maximizing overall efficacy.

The systems can be used to jointly estimate cost and efficacy of a radiologist across different tasks, assign radiologists tasks automatically, and be able to maximize the expected improvement in the proactive learning system in order to better assign tasks to radiologists. The systems can provide both reductions in healthcare costs, while maintaining quality of care.

In FIG. 6, each user is represented by a statistical model (e.g., M1). This statistical model can include information from both the current user profile and metrics profile for the user. The expected utility of each agent can be computed using this statistical model.

In some embodiments, an assigner module can allow for manual selection of tasks. For example, a different healthcare professional can assign tasks to users based on the estimations of the assigner module.

In some embodiments, an assigner module provides automated task recommendations. The same task can be assigned to multiple users. For example, if there are three low cost users, they may be preferred over one high cost user even if that user has a better efficacy.

An assigner module can assign tasks based on maximum information gain for the proactive learning system. For example, the system can recommend a task which may best improve the understanding of the current user's abilities and cost.

Control Systems

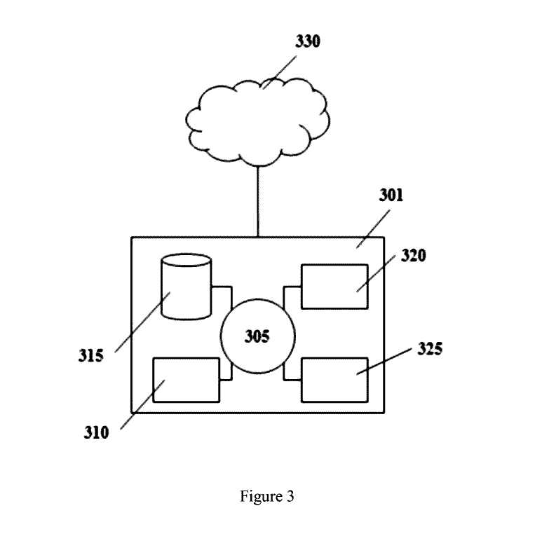

The present disclosure provides computer control systems that are programmed to implement methods of the disclosure. FIG. 3 shows a computer system 301 that is programmed or otherwise configured to retrieve patient data according to a personalized retrieval system. The computer system 301 can regulate various aspects of data retrieval of the present disclosure, such as, for example, generation of relevance scores, similarity ratings, and relevance functions.

The computer system 301 includes a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage and/or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet and/or extranet, or an intranet and/or extranet that is in communication with the Internet. The network 330 in some cases is a telecommunication and/or data network. The network 330 can include one or more computer servers, which can enable distributed computing, such as cloud computing. The network 330, in some cases with the aid of the computer system 301, can implement a peer-to-peer network, which may enable devices coupled to the computer system 301 to behave as a client or a server.

The CPU 305 can execute a sequence of machine-readable instructions, which can be embodied in a program or software. The instructions may be stored in a memory location, such as the memory 310. Examples of operations performed by the CPU 305 can include fetch, decode, execute, and writeback.

The storage unit 315 can store files, such as drivers, libraries and saved programs. The storage unit 315 can store user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 330.

Methods of the disclosure can be implemented by way of machine (e.g., computer processor) executable code stored on an electronic storage location of the computer system 301, such as, for example, on the memory 310 or electronic storage unit 315. The machine executable or machine readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods of the disclosure, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 301 can include or be in communication with an electronic display that comprises a user interface (UI) for providing, for example, an image box to show the image correlated with a patient, the details of a patient, and the annotations of the image correlated with the patient. Examples of UI's include, without limitation, a graphical user interface (GUI) and web-based user interface. In some cases, the electronic display can be provided on a monitor, a smart phone, a tablet, or any other electronic screen and/or projection device in communication with the computer system.

Methods and systems of the present disclosure can be implemented by way of one or more algorithms. An algorithm can be implemented by way of software upon execution by one or more computer processors. In some examples, an algorithm for determining a relevance function comprises a function programmed to automatically learn a correlation between low-level features extracted from queried patient data and users' information needs through the retrieved patient data. For example, a relevance function ƒ_{q} maps each patient sample xᵢ to a real valued relevance rating.

ƒ_{q}:X→[0,1]

The relevance rating can be based on the low-level features of patient data samples X, the log data associated with user feedback R, and the labeled patient data acquired during the retrieval process L.

An algorithm for determining a similarity rating can comprise generating a score by comparing the similarity of the queried data with the data retrieved from the query. For example, a similarity rating can comprise searching a database for patient data images that relate to search parameters input by the user and comparing the retrieved images to the queried search parameters and/or queried patient data. In some instances, a similarity score can be generated if the retrieved images are at least 20, 30, 40, 50, 60, 70, 80, 90 or 100% identical to the queried search parameters and/or queried patient data. Similarity can take into account pixel intensity of the image, texture features of the image, previous patient history, and/or annotations of the image pixels and regions. Similar annotations can refer to similar gradation of disease, severity of disease, and/or description/ontology terms. The similarity rating can be generated by comparing the similarity of the annotations between the queried image and the images in the database. Comparisons can be made by computing a similarity measure between the queried patient data (e.g., images in a database) and the set of patient data being compared (e.g., image of current patient). The patient data and features may be pre-processed with statistical methods, such as normalization and feature selection, before comparisons are made. One example of a common similarity measure can be cosine similarity where the cosine of two vectors representing patient features, A and B is equal to

$$\frac{{A}^{\cdot } B}{‖ A ‖ ‖ B ‖} .$$

The resulting similarity ranges from −1 to 1 where −1 signifies exactly opposite vectors and 1 signifies identical vectors. Comparisons may also be made by converting a distance metric to a similarity measure to produce a similarity rating. There are a number of ways to convert between a distance metric and a similarity measure, such as a kernel. If D is a distance and S is a similarity rating, then S=e^{-D}*^{γ} (γ is a tunable parameter) may be a valid method to convert a distance outputted by a distance metric to a similarity rating. Comparisons may also be made using a statistical distance which quantifies the distance between two patient data distributions. One example of a statistical distance is Kullback-Leibler divergence which can be computed from discrete histograms (representing statistical distributions), P and Q as

$${\sum }_{i} P ( i ) ln \frac{P ( i )}{Q ( i )} .$$

An algorithm for determining a relevance score can comprise learning a Mahalanobis distance metric such that the distance metric is optimized to group similar patient data close together and dissimilar patient data far apart separated by a large distance in feature space. Large Margin Nearest Neighbors (LMNN) is an example of such algorithm to optimize this distance metric and requires knowing patient conditions associated with each image as determined by a physician. See, e.g., Weinberger, K., Blitzer, J., & Saul, L., “Distance metric learning for large margin nearest neighbor classification,” Advances in Neural Information (2006), which is entirely incorporated herein by reference. Another algorithm for determining a relevance score can comprise learning which patient images are similar and dissimilar as indicated either explicitly by the user clicking a button suggesting a search result is relevant or implicitly through the logged search behavior of the user. See, e.g., Xing, E. P., Ng, A. Y., Jordan, M. I., & Russell, S., “Distance Metric Learning, with Application to Clustering with Side-Information,” Advances in Neural Information Processing Systems, 15, 505-512 (2002), which is entirely incorporated herein by reference. Given pairs of similar patient images in the set S of equivalence constraints and pairs of dissimilar patient images in the set D, a distance metric can be formulated as such using convex programming:

$$\begin{matrix}{min}_{A ∈ {R}^{m \times m}} & {\sum }_{( {x}_{i} , {x}_{j} ) ∈ 𝒮} {‖ {x}_{i} - {x}_{j} ‖}_{A}^{2} \\ s . t . & A ≽ 0 , {\sum }_{( {x}_{i} , {x}_{j} ) ∈ 𝒟} {‖ {x}_{i} - {x}_{j} ‖}_{A}^{2} \geq 1\end{matrix}$$

Where A is a positive, semi-definite matrix. Note that if A=I, then the Euclidean distance metric can be determined where all clinical features would be weighted equally. A can be learned such that different clinical features are given different “weights.” Thus, unique preferences can be captured of each user with such a relevance function. Computing a relevance score may involve converting a distance metric to a similarity measure as defined in elsewhere herein.

Methods

The disclosure provides for methods for personalized content retrieval systems.

In some instances, the method comprises accessing a subject database. The subject database can comprise data. The data can be imaging data. The imaging data can be annotated with information about the subject in the images. For example, an x-ray can be annotated with information about the degree of fracture in the bones, the severity of angles of the bones, bone density the weight and height of the patient, and other identifying features.

Accessing a subject database can be performed at the request of a user who can make such a request through the profile module and query module of the systems. The query module can access the subject database.

The method can comprise conducting a search of the database. The database can be searched by a retrieval module and/or retrieval engine. The retrieval engine can search the database by search parameters of the query. The search parameters to be used can be manually input by the user through the profile module. The search parameters to be used can be learned through the adaptive learning methods of the systems such that when a user profile is loaded, the search parameters can be automatically input for the user. An adaptive learning module can be programmed to execute one or more of the adaptive learning methods. The adaptive learning module can be programmed to format patient data for display on a graphical user interface of an electronic device of a user. The patient data can be displayed with a similarity rating that is generated based on similar patients that can be identified based on an input to the query module and a relevance score. The adaptive learning module can adaptively learn the preferences of a user and update the user's relevance function based on the patient data, similarity rating, and relevance score displayed on the graphical user interface of the electronic display.

Search parameters can comprise any parameters related to data in the database. For example, search parameters can be imaging data parameters such as size of image, contrast of image, date of image. A search parameter can comprise annotation data, such as annotation about the severity of the diagnosis (e.g., bone break), the gradation of the diagnosis, the height and weight of the patient, the anatomical feature and the treatment of the patient in the image. A search parameter can include a plurality of search parameters. For example, a search parameter can include a search for images with a certain severity of diagnosis and a specific treatment plan.

When images are retrieved from the database, the retrieval module can use an image comparison algorithm to compare the retrieved images. The image comparison algorithm (e.g., relevance function) can compare the retrieved images to each other. The image comparison algorithm (e.g., relevance function) can comprise the retrieved images to a reference image. The reference image can be an image of a current patient, or a first patient of interest for the user.

The image comparison algorithm (e.g., relevance function) can compare the retrieved images from the database to the query image (e.g., current image) by generating a relevance score and/or a similarity rating. The relevance score can indicate how relevant the results are to the user and/or how reliable the retrieved images are related to the search query and parameters. The similarity rating can indicate how similar the retrieved images are to the query image. The retrieved images and the ratings associated with the retrieved images can be displayed to the user. The images can be formatted for display, for example on a graphical user interface, by a display module.

The methods of the disclosure can comprise retrieving feedback from the user about the displayed images. A graphical user interface of the display module can provide a space for a user can manipulate the displayed images and/or provide feedback about the displayed images. For example, the user can provide explicit feedback about the images. Explicit feedback can refer to active feedback by the user. In other words, explicit feedback can refer to manual input by the user about the displayed images. For example, explicit feedback from a user can comprise selecting an option from the graphical user interface (such as rearranging the order of the displayed images, and/or removing images).

In some instances, the user can provide implicit feedback about the displayed images that the systems can automatically detect. For example, implicit feedback such as at least one or all of search histories, times hit on the refresh button, time spent on a specific image, number of times an image is viewed, can be automatically tracked by the systems. The implicit feedback can be learned by the systems and can be reflected in an updated relevance function. Both explicit and implicit user feedback from the user can be used to determine if the retrieved images accurately relate to the search parameters, or do not accurately relate to the search parameters. An image can accurately relate to the search parameters when the at least about 50%, 60%, 70%, 80%, 90%, or 100% of the images displayed by the system relate to the search parameters, such as, for example, upon comparison of the image to a reference image that has been identified to relate to the search parameters (e.g., a reference picture of a heart is selected to relate to the term “heart”).

The feedback from the user can be used to update the image comparison algorithm (e.g., relevance function). The next search performed can take into account both the explicit and implicit user feedback. In this way the systems can be considered adaptive learning systems.

Image Recommending

In some instances, the disclosure provides for a method for recommending an image to a user. For example, the systems can recommend an un-annotated radiological image to a radiologist for annotation.

In some instances, the method comprises assigning imaging data to a user from a subject database. The subject database can comprise data. The data can be un-annotated imaging data (e.g., tasks for the user to review).

The systems can recommend an image to a user based on the relevance function of the user profile. For example, if the user is an expert in MRI images, which can be reflected in the relevance function, the recommender module can recommend MRI images to that particular user.

When an image (e.g., task) is recommended to a user, the user can evaluate the image to make a clinical decision. A clinical decision can comprise, for example, a diagnosis, an evaluation of the severity of the problem and/or diagnosis, and/or determination of a treatment plan for the patient. The clinical decisions can be evaluated by the metrics module of the system. The metrics module can evaluate the clinical decisions based on user feedback. For example, an attending physician can evaluate the clinical decisions of the user, and either approve or reject the clinical decision. The metrics module can incorporate that feedback by updating the recommender module for which images get recommended to which patients. For example, a user that makes multiple mistakes on the same issue may not receive images related to that issue in the future.

The system can access the metrics profile of the user to update the metrics profile depending on the accuracy of the evaluation of the clinical decision. The metrics profiles can be given to a supervisor (e.g., a boss, an attending physician) as an evaluation of the users. The metrics profiles can be incorporated into the recommender module of the systems such that the recommender module recommends images based on a user metric. For example, if a user is known to be less accurate in their clinical evaluations then the same image may be sent out to a second user with a higher rating in the metrics profile, such that the image can be evaluated by two users with at least one having a higher likelihood of making a correct clinical evaluation.

Image Prioritization

In some instances, the systems can automatically prioritize an image. Image prioritization can advantageously reduce time and resources required by a reviewing or treating physician to make an accurate diagnosis. The systems can flag some images as having a higher priority relative to other images, and a physician or radiologist can review only those images, thus saving considerable time in analyzing images associated with a particular scan.

Systems can automatically prioritize an image. In some embodiments, the systems can be configured to flag an image as having a “high priority” or a “low priority.” In some embodiments, the systems can flag an image as having high, medium or low priority. In some embodiments, the systems can categorize an image among a predetermined number of categories. For example, one, two, three, four, five, six, seven, eight, or more categories may be utilized. The systems can assign a relevance score and/or a similarity rating to an image that is indicative of the priority of the image. For example, a high relevance/similarity image can be assigned a numerical value of 1, while a low relevance/similarity image can be assigned a numerical value of 0. In some embodiments, the user can specify how an image is to be prioritized. For example, the user can specify that images are to be prioritized as high, medium, or low priority.

In some embodiments, a user (e.g., a reviewing/referring physician, radiologist) can request that the system only provide images having a priority that is above a minimum (or cut-off) priority. For example, the user can request that the systems provide only high priority images for review. As another example, the user can request that the systems provide images having a priority numerical value above a certain value or within a certain range. In some embodiments, the user can specify the minimum (cut-off) priority.

Case Review and Reporting

The systems can provide one or more images associated with a particular patient, in addition to data associated with each image, to a radiologist (or other reviewing physician) for review. In some embodiments, the systems provide a radiologist an assessment of each image (e.g., a relevance score and/or a similarity rating). In some embodiments, the systems can determine whether a particular ailment or abnormality is present in an image, and provide its assessment (e.g., “A pleural effusion has been detected”) to a reviewing physician.

In some instances, a system can prioritize cases and provide the cases for review by a reviewing physician, such as a radiologist. The radiologist can use a computer terminal in communication with the system to select the case of highest priority from the case queue list. The radiologist can use a reviewing system to retrieve a case. The systems can provide the radiologist an interactive window with images (e.g., two-dimensional cross-sections) from a particular region of a patient's body. The interactive window the systems can provide its assessment of the patient's condition. The systems can permit the radiologist to provide additional information to the patient's case. The systems can also provide a radiologist additional information relevant to a particular image, such as distances, cross-sectional areas, and volumes.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

### EXAMPLES

### Example 1

### Similar Patient Concept

A radiologist uses the personalized content-based patient retrieval system as described herein implemented as a standalone application. The radiologist queries a patient from a PACS and retrieves all available patient data. The radiologist then selects the patient's user profile, creating a new one if the profile does not exist in the user profile database. The radiologist sets user preferences for the query and begins the annotation process of the image. The radiologist queries the database with search parameters that search for similar patients based on the search parameters. The radiologist requests a list of similar patients with similarity based on patient image features, as defined in the search parameters. The radiologist is presented with a list of patients sorted by the similarity to the current patient. The radiologist proceeds to annotate the current patient by toggling back and forth from similar patients.

### Example 2

### Adaptive Learning Concept

A radiologist is viewing search results for a patient where similarity is defined based on radiological annotations. The radiologist then hits a refresh button and the search results along with relevance scores get updated to reflect the changes in similarity after updating the patient information.

### Example 3

### Inconsistent Annotations

A radiologist annotates a patient. The radiologist provides an annotation for the patient that is inconsistent based on previous annotations of similar patients. The specific annotation is highlighted. The radiologist selects the highlighted annotation and a pop-up dialog screen shows relevance score for the annotation with a prompt suggesting an annotation and asking if the radiologist will accept or reject the change. The radiologist can select the highlighted annotation by clicking, tapping, or mousing-over the selection.

### Example 4

### Continual Learning

A user uses the personalized content-based patient retrieval system that is implemented as a standalone application. The user queries a patient from a PACS and retrieves all available patient data. The user then selects his user profile, creating a new one if the profile does not exist in the user profile database. The user sets user preferences for the query and begins the annotation process. The user requests a list of similar patients with similarity based on patient image features. The user is presented with a list of patients sorted in descending order by the relevance score to the current patient. The user then proceeds to select the most relevant patient and the relevance engine updates the user's current profile to reflect the changes in the relevance function. As the user uses the system for different patients, the relevance function continually evolves to reflect the inherent similarity constraints of the user.

### Example 5

### Active Learning with Explicit Feedback

A user queries a patient from a PACS and retrieves all available patient data. The user then selects his user profile and sets user preferences for the query such that the query is defined over both radiological annotations and patient images. The user queries the retrieval engine with the current patient. The relevance engine then displays a list of similar patients with similarity based on patient image features, radiological annotations, and the user's user profile. The user is presented with a list of patients sorted in descending order by the relevance score to the current patient. After the user completes the annotations, he then proceeds to explicitly indicate which patients were relevant to his current study using a graphical user interface (GUI). The relevance engine then updates the user's current profile to reflect the changes in the relevance function. As the user uses the system for different patients, the relevance function continually evolves to reflect the inherent domain knowledge of the user. The relevance function may actively select a set of patients that would provide the most information to the relevance engine rather than just providing results that are the most relevant to the user.

### Example 6

### Continual Learning with Implicit Feedback

A user queries a patient from a PACS and retrieves all available patient data. The user then selects his user profile and sets user preferences for the query such that the query is defined over both radiological annotations and patient history. The user queries the retrieval engine with the current patient. The relevance engine then displays a list of similar patients with similarity based on patient history, radiological annotations, and the user's user profile. The user is presented with a list of patients sorted in descending order by the relevance score to the current patient. The user then proceeds to select patients using a graphical user interface (GUI), review previous patient data, and return back to the current study. As the user uses the retrieval system, the feedback module is continually keeping track of which patients were selected and the amount of time the user spent on each patient. Using this implicit feedback, the relevance engine then updates the user's current profile to reflect the changes in the relevance function. The user then selects the “refresh” button in the GUI which updates the results with a new set of patients based on the past search behavior of the user.

### Example 7

### Recommending Cases to Radiologists

A radiologist uses the personalized content-based patient retrieval system that is implemented as a standalone application. The radiologist selects his user profile, creating a new one if the profile does not exist in the user profile database. The study recommender module receives the selected user profile and requests a metric profile from the metrics module. Then, the recommender module assigns the radiologist a study and the radiologist begins the annotation process. Once the radiologist completes the study, the metrics module evaluates his performance and updates the corresponding metrics profile for the user.

### Example 8

### Assigning Readings to Multiple Radiologists

A user uses the personalized content-based patient retrieval system that is implemented as a standalone application. The assigner module retrieves the user profile, a metric profile from the metrics module, and provides the user with a study based on her predicted efficacy and cost. A second user also uses the same personalized content-based patient retrieval system that is implemented as a standalone application. The assigner module retrieves the second user's user profile, a metric profile from the metrics module, and provides the second user with a study based on his predicted efficacy and cost. The first user and the second user may both be provided the same study as well.

### Example 9

### Method to Compare Images

A user requests a system to perform a search in a database through a graphical user interface to find images similar to a current patient image. The database comprises imaging data of patients. The imaging data is annotated with descriptions about the physiological state and/or condition of the patient in the image. The search is performed with a computer processor. The user enters search parameters into the graphical user interface. The system searches the database based on the search parameters and retrieves images. The system calculates the similarity and relevance of the retrieved images. The retrieved images and the score of the similarity and/or relevance can be shown to the user on the graphical display.

The user provides feedback to the system. Feedback to the similarity of the retrieved images is given by the user, sometimes in the form of explicitly rejecting the image, and sometimes in the form of not looking at the image. The system accepts the feedback and updates itself (e.g., its relevance function for that user) such that on a second query the system incorporates the feedback.

The user updates the annotations of the current patient image based on the retrieved images. The updated annotations are reflected in the relevance function of the system as well such that upon a second query (e.g., refresh of the retrieved images) the retrieved images relevance score is recalculated based on the updated annotations.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for adaptive learning of imaging data, comprising:
(a) upon request by a user, accessing a subject database comprising subject imaging data, which imaging data is related to a physiological state or condition of one or more subjects, wherein at least a fraction of the subjects have known or identifiable physiological conditions;
(b) using a computer processor, conducting a search of said subject database directed to search parameters provided by said user, wherein said search parameters include one or more image data associated with a subject undergoing treatment, and wherein said search comprises comparing, using an image comparison algorithm, said one or more search parameters to said subject imaging data in said database;
(c) providing, on a user interface of an electronic display of said user, one or more matches of said search, which matches include one or more imaging data among said subject imaging data each associated with a known or identifiable condition;
(d) retrieving from said user an indication as to whether said one or more matches of (c) (i) accurately relate to said one or more image data associated with said subject or (ii) do not accurately relate to said one or more image data associated with said subject; and
(e) updating said imaging comparison algorithm based on said indication of (d).

2. The method of claim 1, wherein said image comparison algorithm comprises generating a similarity rating using a computer processor.

3. The method of claim 2, wherein said similarity rating indicates how similar said one or more search parameters are to said subject imaging data in said database.

4. The method of claim 1, wherein said image comparison algorithm comprises generating a relevance score.

5. The method of claim 4, wherein said relevance score indicates the relevance of said search results to the user.

6. The method of claim 1, wherein said indication of (d) is tracked through one or more of said user's time spent on a given image, number of times an image is viewed, search history, and number of user selections on an image.

7. The method of claim 1, wherein said indication of (d) is provided by said user manually grading said matches.

8. The method of claim 1, wherein said imaging data is at least in part from an imaging modality.

9. A system for adaptive learning of imaging data, comprising:
(a) a profile module programmed to allow a user to make a profile, said profile comprising a relevance function selected for said user;
(b) a query module programmed to query a patient database for search parameters selected by said user;
(c) a retrieval module that is programmed to use said relevance function to retrieve patient data from said patient database based on said query; and
(d) an adaptive learning module that is programmed to (i) format said patient data for display on a graphical user interface of an electronic device of user, which patient data is displayed together with a similarity rating that is generated based on similar patients that are identified based on the content of said query, and a relevance score, and (ii) adaptively learn the preferences of said user and update said relevance function based on said patient data, similarity rating and relevance score displayed on said graphical user interface of an electronic display.

10. The system of claim 9, wherein said system further comprises a feedback module programmed to allow said user to provide feedback as to the relevancy of said retrieved patient data.

11. The system of claim 9, wherein said profile module is programmed to allow a user to generate a personalized search on said graphical user interface.

12. The system of claim 9, wherein said patient data is selected from the group consisting of: images, clinical data, ontology data, symptoms, and diagnoses, or any combination thereof.

13. The system of claim 9, wherein said relevance score indicates the reliability of the search results.

14. The system of claim 9, wherein said similarity rating indicates the similarity between a query and data retrieved based on said query.

15. The system of claim 9, wherein said relevance function comprises an algorithm that computes a value indicating the relevance of the patient data obtained from a query to a current patient.

16. The system of claim 9, further comprising an assigner module that is programmed to assign said patient data to a second user.

17. The system of claim 9, further comprising a recommender module that is programmed to recommend said patient data based on said relevance function.

18. The system of claim 17, further comprising a metrics module that is programmed to update said recommender module based on evaluations of said patient data by said user, thereby enabling the system to continually recommend relevant patient data.

19. A method for recommending imaging data, comprising:
(a) upon request by a user, accessing a subject database comprising subject imaging data, which imaging data is related to a physiological state or condition of one or more subjects, wherein at least a fraction of the subjects have a known or identifiable physiological conditions;
(b) using a computer processor, conducting a search of said subject database directed to search parameters provided by said user, wherein said search parameters include one or more image data associated with a subject undergoing treatment, and wherein said search comprises recommending, using a recommending algorithm, said subject imaging data in said database;
(c) providing, on an electronic display of said user, one or more recommended imaging data;
(d) retrieving from said user an indication as to the clinical evaluation of said imaging data;
(e) evaluating said clinical evaluation, wherein said evaluating comprises determining the accuracy of said clinical evaluation; and
(f) updating said recommending algorithm based on said indication of (d) and accuracy of (e).

20. The method of claim 19, wherein said evaluating is performed by a second user.

21. The method of claim 19, wherein said recommending algorithm is programmed to recommend said imaging data based on a relevance function in a user profile.
